(19) United States
(12) Patent Application Publication
(10) Pub. No.: US 2008/0080958 A1
(43) Pub. Date: Apr. 3, 2008

(54) Binding device sizing guide

(75) Inventors: James Henderson, Lower Wick (GB); Kester Rudd, Norton (GB)

Correspondence Address: WOOD, PHILLIPS, KATZ, CLARK & MORTIMER, 500 W. MADISON STREET, SUITE 3800, CHICAGO, IL, 60661, US

(73) Assignee: Fellowes, Inc., Itasca, IL (US)

(21) Appl. No.: 11/906,480

(22) Filed: Oct. 2, 2007

(30) Foreign Application Priority Data
Oct. 2, 2006 (GB) 0619417.9

(51) Int. Cl. B42C 13/00; B42C 1/00

(52) U.S. Cl. 412/14; 412/33

(57) ABSTRACT

Disclosed herein is a sizing guide or gage for selecting a binding device to bind a set of sheets using a binding machine typically referred to as a comb binder. The sizing guide includes a plurality of apertures corresponding to a range of binding devices, each aperture corresponding to a particular size of binding device. The aperture includes a rounded portion and is linked to a slot corresponding to the maximum number of sheets to be bound by the binding device corresponding to the aperture. The sizing guide may be formed as part of the binding machine.

### FIELD OF INVENTION

The present invention relates to improvements in or relating to binding machines and in particular to a sizing guide for a binding machine.

### BACKGROUND OF INVENTION

Binding machines are used for binding paper or card documents formed from a set of separate sheets. Typically, the binding machine performs a first function of punching a series of holes in the sheets to be bound and then performs a second function of enabling a binding device such as a comb or coil to be inserted or threaded through the holes to complete the binding process. In order to successfully and optimally bind a document the correct sized coil or comb must be chosen for the given set of sheets. If a comb or coil which is too small is chosen then there is the risk that the sheets of the document will not be securely bound and may become detached in use. If too large a coil or comb is used then the finished product can look aesthetically displeasing and there is also a danger that the pages of the bound document will be too loose. Combs and coils are available in a number of standard sizes such as ¼ inch (6.35 mm), ⅜ inch (9.53 mm), 5/16 inch (7.94 mm), ½ inch (12.7 mm), ⅝ inch (15.88 mm), 1 inch (25.4 mm) and 1½ inch (38.1 mm) sizes. Previously graphical measuring scales have been provided wherein printed markings on a sheet are provided which attempt to allow a user of a binding machine to judge which is the best coil or comb to use. However, such graphical scales are inaccurate and difficult to use quickly when binding a number of documents in succession.

The present invention seeks to provide a device for helping a user of a binding machine choose an appropriate sized comb or coil for each binding operation which is more accurate and quicker to use than conventional devices. The user may use the guide to select a comb for a particular set of sheets, and may also use the guide to determine how many sheets a particular comb can accommodate.

### SUMMARY OF THE INVENTION

Accordingly, the present invention provides a binding machine for binding a set of sheets during a binding operation using a binding device, the binding machine comprising a sizing guide for determining a correct size of binding device to be used in the binding operation dependant on the thickness of the set of sheets to be bound, the sizing guide comprising a plurality of openings of varying size, the openings corresponding to varying sizes of binding device.

The use of openings rather than a printed scale allows for quicker and more accurate use of the sizing guide as a user can easily present the set of sheets to the openings and determine whether there is a correct fit of the sheets in each opening. In contrast trying to correctly align a set of sheets against a printed marking and keep the set aligned while judging by eye whether the set of sheets exceeds a particular dimension is relatively awkward.

Preferably, each opening is provided with a marking or other indication indicating the binding device that corresponds to that opening. In one example, the sizing guide may have printed thereon the size of the corresponding binding device in alphanumeric characters, such as “¼ inch” for a ¼ inch binding device.

Preferably, each opening includes a slot having a width corresponding to the maximum thickness of the set of sheets that should be bound using the binding device corresponding to said opening.

In this way a user can be assured that if the set of sheets fits in the slot the corresponding binding device will be suitable and not too small.

Optionally, the width of each slot is the same as the maximum thickness of the set of sheets that should be bound using the binding device corresponding to said opening. Alternatively, the sizing of the slots can allow for a small margin of error in measurement to help ensure that a user does not try and bind too many sheets with the corresponding binding device. For example, a binding device capable of binding 25 sheets of A4 paper having a weight of 80 g/m² may have a slot width in the sizing guide which can accommodate a maximum of 23 sheets only.

Preferably each opening includes an aperture having a characteristic dimension corresponding to the diameter of the binding device corresponding to said opening.

In this way the same sizing guide may be used to measure the binding devices, such as coils or combs, to ensure that the correct size is used in the subsequent binding operation.

Preferably the aperture includes a rounded portion. The rounded portion of each opening may be linked to a slot portion of said opening. The rounded aperture may be positioned near or adjacent to the slot, or it may be in communication with the slot.

For example, a user may determine, in a first step by presenting the set of sheets to successive slots of the plurality of openings, that a binding device of size ½ inch (12.7 mm) is the optimum size for the number of sheets sought to be bound. The user may then select the correct binding device from the storage tray. If they are in doubt as to the size of the binding device the user may present the end of the binding device to the rounded portion of the opening to check that the binding device is of a matching size.

The sizing guide may be formed as an integral part of a component of the binding machine. For example, the guide may be formed as an integral part of a storage tray of the binding machine or an integral part of a waste bin of the binding machine.

Advantageously forming the sizing guide as an integral part of a component of the binding machine ensures that the sizing guide is not easily lost and is readily available for use. Incorporating the sizing guide as part of the storage tray is preferred since the binding devices are then close at hand when the sizing step is undertaken. Advantageously, the storage tray may be provided with separate compartments for each size of binding device and further, the sizing guide may be provided with a graphical indication linking each opening with a corresponding compartment of the storage tray.

As an alternative the sizing guide may be a separate part from a body of the binding machine.

Preferably, the sizing guide is moveable between a storage position, in which the sizing guide is substantially contained within a body of the binding machine, and an operating position, in which the sizing guide is extended or removed from the body of the binding machine to allow sets of sheets to be sized.

The sizing guide may be arranged to slide laterally or forwards and backwards relative to a front edge of the binding machine between the storage and operating positions.

The sizing guide may be formed from plastic.

The binding device may be a comb, coil, or similar device.

The present invention also provides a binding machine sizing guide, the binding machine being of the type used for binding a set of sheets during a binding operation using a binding device, and the sizing guide including a plurality of openings of varying size, the openings corresponding to varying sizes of binding device.

Preferably each opening defines a slot having a width corresponding to the maximum thickness of the set of sheets that should be bound using the binding device corresponding to said opening.

The width of each slot may be the same as the maximum thickness of the set of sheets that should be bound using the binding device corresponding to said opening.

Embodiments of the present invention will now be described, by way of example only, with reference to the accompanying drawings.

In summary, the invention provides for a sizing guide for selecting a binding device to bind a set of sheets, the sizing guide including plurality of apertures corresponding to a range of binding devices, each aperture corresponding to a particular size of binding device, the aperture including a rounded portion and linked to a slot corresponding to the maximum number of sheets to be bound by the binding device corresponding to the aperture. The linking of the slot to the rounded portion may be done by locating the slot adjacent to the rounded portion, or placing them in communication with each other.

### BRIEF DESCRIPTION OF THE DRAWINGS

FIG. 1 is a plan view of a first embodiment of binding machine according to the present invention;

FIG. 2 is a plan view of the binding machine of FIG. 1 with an upper cover in an open position;

FIG. 3 is a plan view of a comb storage tray of the binding machine in FIG. 1;

FIG. 4 is a perspective view of an alternative embodiment of storage tray for a binding machine according to the present invention;

FIG. 5 is a perspective view of the storage tray of FIG. 4; and

FIG. 6 is a plan view of the storage tray of FIG. 4.

### DETAILED DESCRIPTION OF THE PREFERRED EMBODIMENT

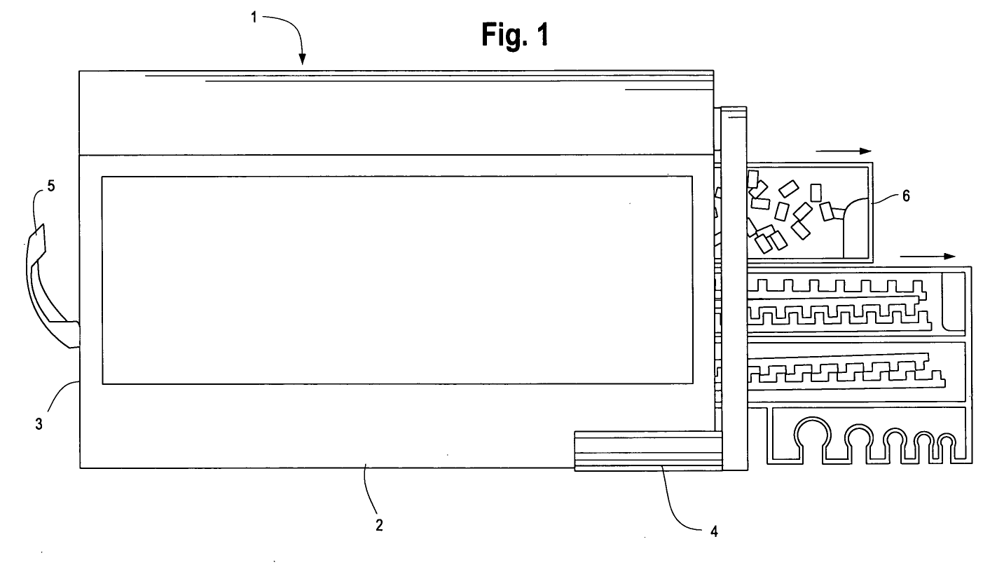

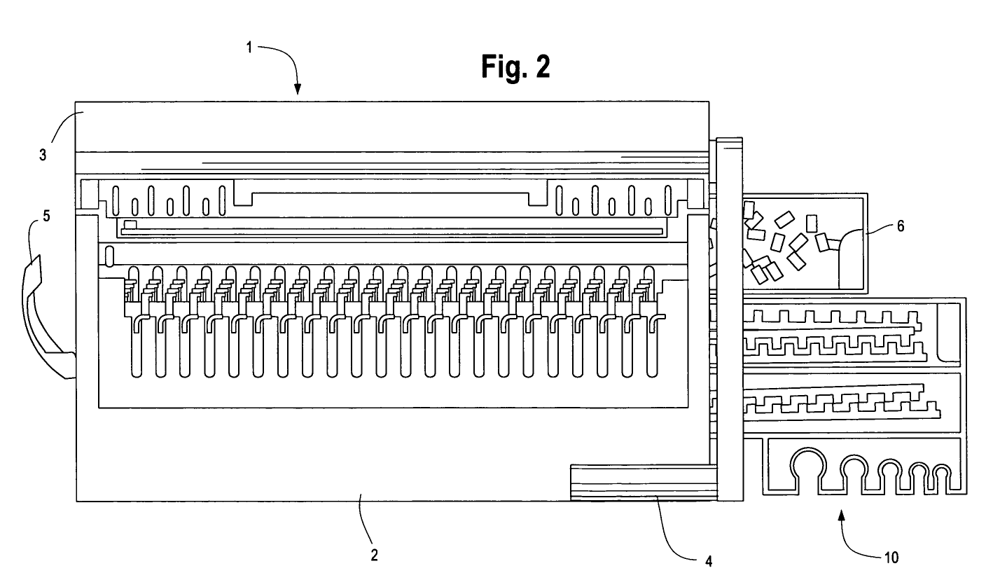

As shown in FIGS. 1 and 2, the binding machine 1 comprises a housing 2 having an upper cover 3 which is movable between closed and open positions as shown respectively in FIGS. 1 and 2. The upper cover 3 covers the internal mechanisms of the binding machine 1 such as the hole punch mechanism (not shown) and the comb fitting unit 7. One skilled in the art will recognize that the hole punch mechanism is not crucial to the invention.

A first operating lever 4 (punch handle) is provided for operating the hole punch mechanism and a second operating lever 5 (comb opening lever) is provided for operating the comb fitting unit 7.

An elongate waste bin 6 is provided located immediately beneath the hole punch mechanism for collecting the chads ejected in use from the hole punch mechanism. The waste bin 6 may be slid laterally into and out of a side of the housing 2 to allow the waste bin 6 to be easily emptied.

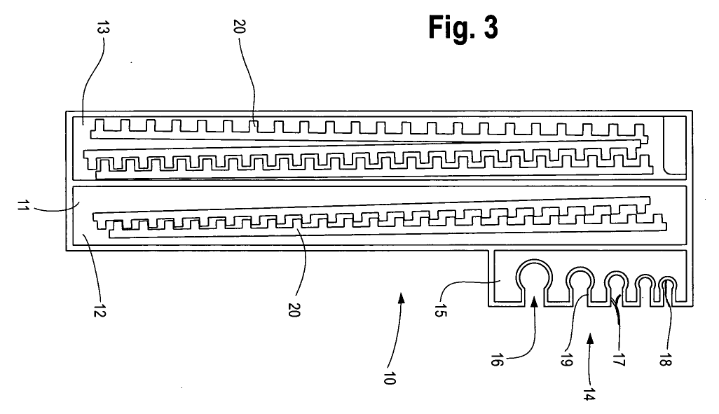

According to the present invention there is also provided a storage tray 10 having a sizing guide. The storage tray 10, as most clearly shown in FIG. 3, is elongate and generally rectangular in shape and is preferably formed as an integral moulding from a plastics material. The storage tray 10 comprises two receptacles 12, 13 in which plastic or wire combs or coils 20 may be stored prior to use and a flange 15 which is provided as an integral part of the storage tray 10. The flange 15 projects forwardly from the receptacles 12, 13 and, when the storage tray is positioned in the binding machine as shown in FIG. 2, is directed towards a front edge of the binding machine 1. The flange 15 is provided with a series of openings 16 in a front edge thereof forming a sizing guide 14. Each opening 16 comprises a rounded portion 18 which is linked to the front edge by means of a slot 19 defined by two parallel edge walls 17. With such construction, the rounded portion 18 and the slot 19 are in communication. However, such communication is not required, and the rounded portion 18 and the slot 19 defined by parallel edge walls 17 may be merely adjacent one another, with a structure, such as a wall, between them.

As most clearly seen in FIG. 3, the openings 16 have a range of sizes progressing from a smallest opening at one end of the flange 15 to a largest opening at an opposed end of the flange 15. Each of the openings 16 is designed to equate to a standard size of comb or coil to be used with the binding machine 1 and is provided with an etched or printed marking or indicia indicating the size of the corresponding comb or coil.

As shown, the openings 16 are bottomless, in other words, the openings pass through the full depth of the flange 15.

In use, a user of the binding machine 1 may determine the correct size of coil or comb 20 to be used for each binding operation by collating the sheets to be bound into a set and bringing the set of sheets up to interface with the openings 16 of the sizing guide 14. The fixed spacing of the parallel walls 17 of the slot of each opening 16 determines a maximum number of sheets (or width of material) that can be inserted into each opening 16. Thus, a user can attempt to insert the set of sheets to be bound into each opening 16. If the set of sheets to be bound are too thick to be inserted into one opening then the user may try the next larger opening until an opening 16 is found in which the set of sheets to be bound can be inserted. At this point, the user can read off the size of comb or coil that is required from the markings or indicia on the sizing guide 14. It will be noted that the rounded portion 18 of each opening 16 is generally of the size and shape of the rounded portion of the corresponding coil or comb 20. Thus, the user can use the rounded portion 18 of the openings 16 as a means for measuring the size of the combs or coils 20 contained in the storage tray 10 by inserting an end portion of the comb or coil into the rounded portion 18.

The binding step can then be undertaken using the optimum coil or comb 20 which is then selected from one of the receptacles 12, 13 of the storage tray and, if required, measured using the rounded portions 18 of the openings 16.

Advantageously, when the storage tray 10 is not in use it may be slid sideways into the housing 2 of the binding machine in a similar manner to the waste receptacle 6.

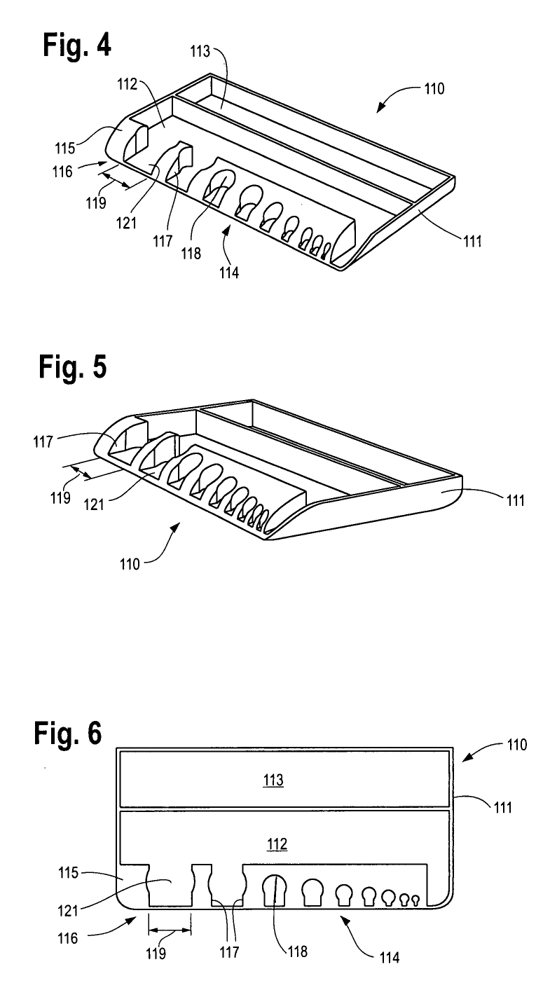

FIGS. 4 to 6 show an alternative embodiment of sizing guide 114. In this sizing guide 114 the storage tray 110 is designed to be slid forwards and backwards into and out of the binding machine 1 rather than slid laterally as in the first embodiment. As before, the tray 110 provides two storage receptacles 112, 113 for storing the combs or coils 20 before use and provides a series of opening 116 of varying sizes, each size equating to a standard size of comb or coil. A flange 115 extends forwards from the receptacles 112, 113 and defines a front edge of the tray 110. In the illustrated embodiment the flange 115 extends along the full width of the storage tray 110.

As before each opening 116 comprises a rounded portion 118 joined to the front edge of the flange 115 by a slot 119 defined by two parallel walls 117. The width of the slot 119 determines the maximum width of material that can be inserted into the opening 116 during the measuring step. In this embodiment, the openings 116 do not pass through the entire height of the flange 115 but are provided with a closed base 121. In practice the user wishing to determine the correct size of comb or coil to be used for a binding operation places an end portion of the set of sheets to be bound in the successive openings 116 resting on the base 119 until the correct sized opening 116 is determined. Then the correct coil or comb to be used can be read off using the markings indicated on the flange 115. As in the first embodiment the rounded portions may also be used to measure the combs or coils 20.

In the embodiments described above, the sizing guide has been described as integrally moulded as part of a comb or coil storage tray 10, 110. However, the sizing guide may also be moulded or formed as part of another portion of the binding machine 1 or may be provided as a separate, removable unit which is not integral with the binding machine 1.

1. A binding machine for binding a set of sheets during a binding operation using a binding device, the binding machine including a sizing guide for determining a correct size of binding device to be used in the binding operation dependant upon the thickness of the set of sheets to be bound, the sizing guide including a plurality of openings, the size of each opening corresponding to a particular size of binding device.

2. A binding machine as claimed in claim 1 wherein each opening includes a slot having a width corresponding to the maximum thickness of the set of sheets that should be bound using the binding device corresponding to said opening.

3. A binding machine as claimed in claim 2 wherein the width of each slot is the same as the maximum thickness of the set of sheets that should be bound using the binding device corresponding to said opening.

4. A binding machine as claimed in claim 1 wherein each opening defines an aperture having a characteristic dimension corresponding to the diameter of the binding device corresponding to said opening.

5. A binding machine as claimed in claim 1, wherein an opening includes a rounded portion in communication with the slot portion of the opening.

6. A binding machine as claimed in claim 1 wherein the rounded portion of each opening is linked to a slot portion of said opening.

7. A binding machine as claimed in claim 1 wherein the sizing guide is formed as an integral part of a component of the binding machine.

8. A binding machine as claimed in claim 7 wherein the sizing guide is formed as an integral part of a storage tray of the binding machine.

9. A binding machine as claimed in claim 7 wherein the sizing guide is formed as an integral part of a waste bin of the binding machine.

10. A binding machine as claimed in claim 1, wherein the sizing guide includes a base portion limiting the travel of a biding device through an opening of the sizing guide.

11. A binding machine as claimed in claim 1 wherein the sizing guide may be moveable between a storage position, in which the sizing guide is substantially contained within a body of the binding machine, and an operating position, in which the openings of the sizing guide outside of the body of the binding machine.

12. A binding machine as claimed in claim 11 wherein the sizing guide is part of a storage tray.

13. A binding machine as claimed in claim 1 wherein the binding device is selected from the group including a comb or a coil.

14. A sizing guide for determining the proper size binding device to use in binding a set of sheets during a binding operation using a binding machine, the sizing guide including a plurality of openings of, the openings including a slot portion and a rounded portion adjacent each other, the rounded portion sized to correspond to the size of a binding device, the slot portion having a width corresponding to the maximum thickness of the set of sheets that should be bound using the binding device corresponding to the rounded portion.

15. A sizing guide as claimed in claim 14 wherein the slot portion and the rounded portion are in communication with each other.

16. A sizing guide as claimed in claim 15 wherein the diameter of the rounded portion corresponds to the diameter of the binding device corresponding to the opening.

17. A sizing guide as claimed in claim 14 wherein the sizing guide is part of the binding machine.

18. A sizing guide as claimed in 14 wherein the sizing guide is movable between a storage position in which the sizing guide is contained within a body of the binding machine, and an operating position in which the openings of the sizing guide are outside of the body of the binding machine.

19. A sizing guide as claimed in claim 14 wherein the sizing guide is formed as an integral part of a storage tray.

20. A sizing guide for selecting a binding device to bind a set of sheets, the sizing guide including plurality of apertures corresponding to a range of binding devices, each aperture corresponding to a particular size of binding device, the aperture including a rounded portion and linked to a slot corresponding to the maximum number of sheets to be bound by the binding device corresponding to the aperture.
